(19) United States
(12) Patent Application Publication
(10) Pub. No.: US 2024/0399623 A1
(43) Pub. Date: Dec. 5, 2024

(54) INTERNAL MIXING EXTRUDER

(71) Applicant: WUXI BOYU PLASTIC MACHINERY CO., LTD., Wuxi (CN)

(72) Inventor: Dingyi LU, Wuxi (CN)

(73) Assignee: WUXI BOYU PLASTIC MACHINERY CO., LTD., Wuxi (CN)

(21) Appl. No.: 18/700,718

(22) PCT Filed: Oct. 10, 2022
(86) PCT No.: PCT/CN2022/124429

§ 371 Date: Apr. 12, 2024

(30) Foreign Application Priority Data
Oct. 14, 2021 (CN) 202122479470.9

(51) Int. Cl. B29B 7/20; B29B 7/24; B29C 48/67

(52) U.S. Cl. CPC B29B 7/20; B29B 7/24; B29C 48/67

(57) ABSTRACT

An internal mixing extruder includes an internal mixing mechanism including a mixing chamber, where the mixing chamber includes a rear end provided with a first feed port, and a front end provided with a first discharge port, and a rotor is provided in the mixing chamber along a front-rear direction; an extrusion mechanism located below the internal mixing mechanism, where the extrusion mechanism includes an extruding chamber, the extruding chamber includes a rear end provided with a second feed port, and a front end provided with a mold, and a screw is provided in the extruding chamber along the front-rear direction; and a hopper, where the hopper is connected between the first discharge port and the second feed port. Materials are plasticized fully in the internal mixing mechanism. The fully plasticized materials enter the hopper. The hopper conveys to-be-extruded materials to the extrusion mechanism in a forced feeding manner.

### CROSS-REFERENCE TO THE RELATED APPLICATIONS

This application is the national phase entry of International Application No. PCT/CN2022/124429, filed on Oct. 10, 2022, which is based upon and claims priority to Chinese Patent Application No. 202122479470.9, filed on Oct. 14, 2021, the entire contents of which are incorporated herein by reference.

### TECHNICAL FIELD

The present application relates to the technical field of plastic processing, and in particular to an internal mixing extruder.

### BACKGROUND

In an extrusion stage of existing polyvinyl chloride (PVC) flooring production, materials are mixed by a high-speed mixer to about 120° C., discharged to a cooling mixer for cooling, and plasticized forcibly by a conical twin-screw extruder with a good shear force. This process is highly energy-consuming. Specifically, the materials are firstly heated for about 20-40 min, cooled at the high temperature, and discharged to the extruder heated to 190-200° C. In the extruder, the materials are plasticized and extruded into a panel. By heating the materials to 120-135° C. through the high-speed mixer and then cooling the materials to about 50° C. through the cooling mixer, there is a temperature difference of 70-85° C. to cause high energy consumption, long mixing time, and a high mixing cost. Moreover, the materials are only plasticized by means of forced shearing and frictional heating of a screw of the extruder. For a PVC hard product without a plasticizer, a plasticization effect is undesirable.

### SUMMARY

The present application is intended to solve at least one of the technical problems in the prior art. In view of this, the present application provides an internal mixing extruder.

According to a first aspect of the present application, an embodiment provides an internal mixing extruder, including an internal mixing mechanism including a mixing chamber, where the mixing chamber includes a rear end provided with a first feed port, and a front end provided with a first discharge port, and a rotor is provided in the mixing chamber along a front-rear direction; an extrusion mechanism located below the internal mixing mechanism, where the extrusion mechanism includes an extruding chamber, the extruding chamber includes a rear end provided with a second feed port, and a front end provided with a mold, and a screw is provided in the extruding chamber along the front-rear direction; and a hopper, where the hopper is connected between the first discharge port and the second feed port.

The internal mixing extruder according to the embodiment of the present application at least has the following beneficial effects: The hopper is connected between the first discharge port and the second feed port, such that materials upon internal mixing can directly enter the extrusion mechanism, thereby improving an efficiency in extrusion. Materials are plasticized fully in the internal mixing mechanism. The fully plasticized materials enter the hopper. The hopper conveys to-be-extruded materials to the extrusion mechanism in a forced feeding manner. Under an action of the screw and the mold, the materials are extruded for forming. The rotor is located in the mixing chamber for the internal mixing, thereby reducing a hazard of dust to an environment. Therefore, the present application has a high degree of automation, reduces manpower, omits stirring and cooling, and lowers energy consumption. The present application is applied to the application field of the internal mixing extruder, and can achieve a high working efficiency.

According to some embodiments of the present application, the rotor is a double-kneading structure; the rotor includes a rotor shaft; and a material conveying segment, a first mixing segment, a first helical segment, a second mixing segment, and a first discharge segment are arranged sequentially on the rotor shaft.

According to some embodiments of the present application, a second helical segment is further provided between the second mixing segment and the first discharge segment.

According to some embodiments of the present application, the rotor is a single-kneading structure; the rotor includes a rotor shaft; and a material conveying segment, a mixing segment, and a second discharge segment are arranged sequentially on the rotor shaft.

According to some embodiments of the present application, a third helical segment is further provided between the mixing segment and the second discharge segment.

According to some embodiments of the present application, a forced feeding device is provided in the hopper; the forced feeding device includes two parallel rotating shafts; a blade is provided on each of the rotating shafts; and the two rotating shafts rotate relatively.

According to some embodiments of the present application, the two rotating shafts are respectively driven by a driving gear and a driven gear that are engaged to each other.

According to some embodiments of the present application, the screw refers to conical twin screws, a single screw or parallel twin screws.

Additional aspects and advantages of the present application will be partly provided in the following description, and partly become evident in the following description or understood through the practice of the present application.

### BRIEF DESCRIPTION OF THE DRAWINGS

The additional aspects and advantages of the present application will become apparent and readily understood from the descriptions of the embodiments with reference to the following accompanying drawings, in which:

FIG. 1 is a schematic structural view of an internal mixing extruder according to an embodiment of the present application;

FIG. 2 is a schematic view of a first structure of a rotor;

FIG. 3 is a schematic view of a second structure of a rotor;

FIG. 4 is a schematic view of a third structure of a rotor; and

FIG. 5 is a schematic view of a fourth structure of a rotor.

In the figures: 100: internal mixing mechanism, 110: mixing chamber, 120: first feed port, 130: first discharge port, 140: rotor, 141: rotor shaft, 142: material conveying segment, 143: first mixing segment, 144: first helical segment, 145: second mixing segment, 146: first discharge segment, 147: second helical segment, 148: mixing segment, 149: second discharge segment, 150: third helical segment, 200: extrusion mechanism, 210: extruding chamber, 220: second feed port, 230: mold, 240: screw, 300: hopper, and 310: forced feeding device.

### DETAILED DESCRIPTION OF THE EMBODIMENTS

The embodiments of the present application are described below in detail. Examples of the embodiments are shown in the drawings. The same or similar numerals represent the same or similar elements or elements having the same or similar functions throughout the specification. The embodiments described below with reference to the drawings are exemplary, and are merely intended to explain the present application, rather than to limit the present application.

It should be understood that, in the description of the present application, the orientation or position relationships indicated by terms such as “upper”, “lower”, “front” and “rear” are shown in the drawings. These terms are merely intended to facilitate and simplify the description of the present application, rather than to indicate or imply that the mentioned apparatus or component must have a specific orientation or must be constructed and operated in a specific orientation. Therefore, these terms should not be understood as a limitation to the present application.

In the descriptions of the present application, the “a plurality of” means one or more. The “multiple” means two or more. The “first” and “second” are merely intended to distinguish technical features, rather than to indicate or imply relative importance or implicitly indicate a number of the indicated technical features or implicitly indicate a chronological relationship of the indicated technical features.

In the description of the present application, unless otherwise explicitly defined, the words such as “connect” should be understood in a broad sense, and those skilled in the technical field can reasonably determine the specific meanings of the above words in the present application in combination with specific contents of the technical solutions.

Referring to FIG. 1, an internal mixing extruder according to the embodiment of the present application includes: internal mixing mechanism 100, extrusion mechanism 200, and hopper 300. The internal mixing mechanism includes mixing chamber 110. The mixing chamber 110 includes a rear end provided with first feed port 120, and a front end provided with first discharge port 130. Rotor 140 is provided in the mixing chamber 110 along a front-rear direction. The rotor 140 is configured to disperse and plasticize materials quickly. The rotor 140 may be rotatably provided in the sealed mixing chamber 110, thereby reducing a hazard of dust to an environment. It is to be noted that the rear end of the mixing chamber 110 is located on a top of the mixing chamber 110, and the front end of the mixing chamber 110 is located on a bottom of the mixing chamber 110. The extrusion mechanism 200 is located below the internal mixing mechanism 100. The extrusion mechanism 200 includes extruding chamber 210. The extruding chamber 210 includes a rear end provided with second feed port 220, and front end provided with mold 230. Screw 240 is provided in the extruding chamber 210 along the front-rear direction. The screw 240 is used for extrusion of the materials. The mold 230 and the screw 240 co-extrude the materials for forming. It is to be noted the rear end of the extruding chamber 210 is located on a top of the extruding chamber 210, and the front end of the extruding chamber 210 is located on a bottom of the extruding chamber 210. The hopper 300 is connected between the first discharge port 130 and the second feed port 220. The present application has a simple structure, a high efficiency and environmental protection, and can be manufactured or used. The present application is applied to the field of plastic processing and production, and can work continuously. Specifically, the hopper 300 is connected between the first discharge port 130 and the second feed port 220, such that the present application can continuously realize the internal mixing and the extrusion. Therefore, the present application improves a working efficiency in the internal mixing and the extrusion, and is applied to the field of plastic processing and production.

For example, from the internal mixing when the materials enter the internal mixing mechanism 100 to the extrusion, when the internal mixing extruder works, the materials are conveyed to the internal mixing chamber 110 from the first feed port 120 for the internal mixing. The rotor 140 starts rotating for the internal mixing. The materials upon the internal mixing are conveyed to the hopper 300 from the first discharge port 130. The hopper 300 feeds the materials forcibly, such that the materials enter the extruding chamber 210 quickly for the extrusion. The screw 240 starts rotating for the extrusion. Under a combined action of the mold 230 and the screw 240, the materials are extruded for forming.

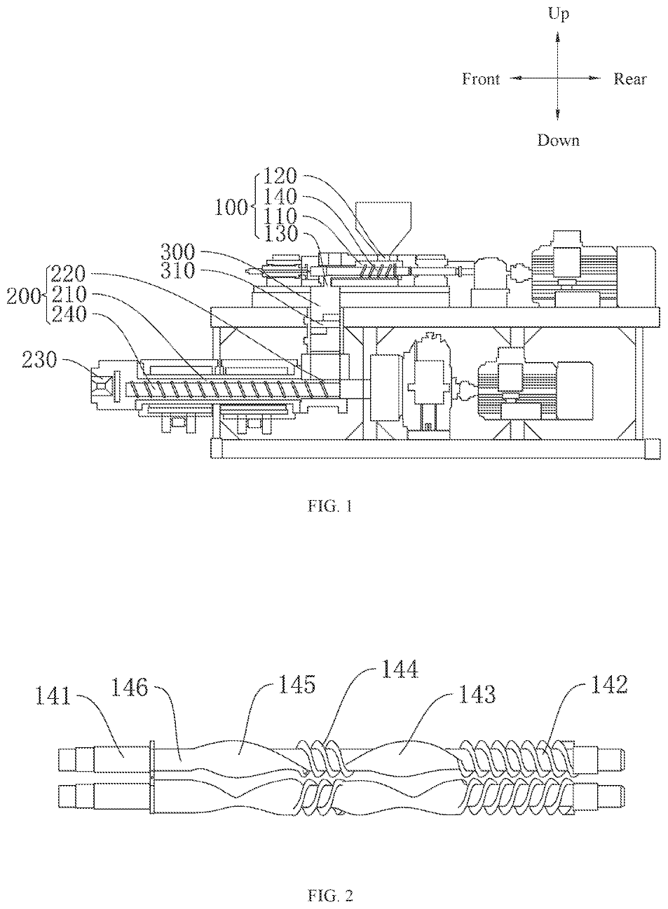

In some embodiments of the present application, as shown in FIG. 2, the rotor 140 is a double-kneading structure. The rotor 140 includes rotor shaft 141. Material conveying segment 142, first mixing segment 143, first helical segment 144, second mixing segment 145, and first discharge segment 146 are arranged sequentially on the rotor shaft 141. With the rotor, the materials can be effectively filled in the whole mixing chamber in internal mixing. With a high fill rate and a good dispersity, the rotor is applicable to a temperature-sensitive material, and makes the material plasticized desirably.

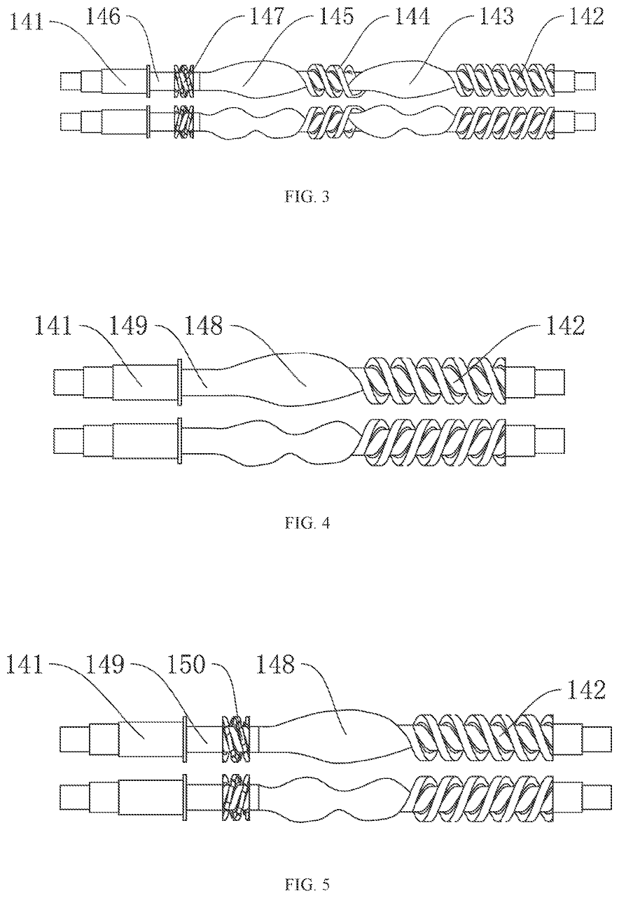

In a further embodiment of the present application, as shown in FIG. 3, the rotor 140 is a double-kneading structure. The rotor 140 includes rotor shaft 141. Material conveying segment 142, first mixing segment 143, first helical segment 144, second mixing segment 145, and first discharge segment 146 are arranged sequentially on the rotor shaft 141. Second helical segment 147 is further provided between the second mixing segment 145 and the first discharge segment 146. The whole rotor is lengthened to facilitate discharge of the materials. Before discharged, the original blocky materials are cut into small bulk materials or large granular materials. This facilitates conveyance of the materials to the extruding chamber, and can further improve the plasticization effect and shorten the time.

In some embodiments of the present application, as shown in FIG. 4, the rotor 140 is a single-kneading structure. The rotor 140 includes rotor shaft 141. Material conveying segment 142, mixing segment 148, and second discharge segment 149 are arranged sequentially on the rotor shaft 141. The rotor 140 has a strong universality and a good material conveying stability.

In a further embodiment of the present application, as shown in FIG. 5, the rotor 140 is a single-kneading structure. The rotor 140 includes rotor shaft 141. Material conveying segment 142, mixing segment 148, and second discharge segment 149 are arranged sequentially on the rotor shaft 141. Third helical segment 150 is further provided between the mixing segment 148 and the second discharge segment 149. The whole rotor 140 is lengthened to facilitate discharge of the materials. Before discharged, the original blocky materials are cut into small bulk materials or large granular materials. This facilitates conveyance of the materials to the extruding chamber, and can further improve the plasticization effect and shorten the time.

In some embodiments of the present application, as shown in FIG. 1, forced feeding device 310 is provided in the hopper 300. The forced feeding device 310 includes two parallel rotating shafts. A blade is provided on each of the rotating shafts. The two rotating shafts rotate relatively. With the forced feeding system, the materials have short residence time to improve a conveying efficiency.

In a further embodiment of the present application, the two rotating shafts are respectively driven by a driving gear and a driven gear that are engaged to each other. The driving gear and the driven gear are configured to provide an initial impetus for rotation of the rotating shaft.

In some embodiments of the present application, as shown in FIG. 1, the screw 240 refers to conical twin screws, a single screw or parallel twin screws. With the screw 240, the materials are plasticized in the extruding chamber 210 more fully and uniformly to ensure product quality.

In the present application, the description of “some embodiments” or “it is conceivable that” means that a specific feature, structure, material or characteristic described in combination with the embodiment(s) or example(s) is included in at least one embodiment or example of the present application. In this specification, the schematic representations of the above terms do not necessarily refer to the same embodiment or example. In addition, the specific features, structures, materials, or characteristics described may be combined in any suitable manner in any one or more embodiments or examples.

Although the embodiments of the present application have been illustrated and described, those of ordinary skill in the art can understand that various changes, modifications, replacements, and variations may be made to these embodiments without departing from the principle and tenet of the present application, and the scope of the present application is defined by the claims and equivalents thereof.

What is claimed is:

1. An internal mixing extruder, comprising:
an internal mixing mechanism, wherein the internal mixing mechanism comprises a mixing chamber, the mixing chamber comprises a rear end provided with a first feed port, and a front end provided with a first discharge port, and a rotor is provided in the mixing chamber along a front-rear direction;
an extrusion mechanism located below the internal mixing mechanism, wherein the extrusion mechanism comprises an extruding chamber, the extruding chamber comprises a rear end provided with a second feed port, and a front end provided with a mold, and a screw is provided in the extruding chamber along the front-rear direction; and
a hopper, wherein the hopper is connected between the first discharge port and the second feed port.

2. The internal mixing extruder according to claim 1, wherein the rotor is a double-kneading structure; the rotor comprises a rotor shaft; and a material conveying segment, a first mixing segment, a first helical segment, a second mixing segment, and a first discharge segment are arranged sequentially on the rotor shaft.

3. The internal mixing extruder according to claim 2, wherein a second helical segment is further provided between the second mixing segment and the first discharge segment.

4. The internal mixing extruder according to claim 3, wherein the rotor is a single-kneading structure; the rotor comprises a rotor shaft; and a material conveying segment, a mixing segment, and a second discharge segment are arranged sequentially on the rotor shaft.

5. The internal mixing extruder according to claim 4, wherein a third helical segment is further provided between the mixing segment and the second discharge segment.

6. The internal mixing extruder according to claim 1, wherein a forced feeding device is provided in the hopper; the forced feeding device comprises two parallel rotating shafts; a blade is provided on each of the two parallel rotating shafts; and the two parallel rotating shafts rotate relatively.

7. The internal mixing extruder according to claim 6, wherein the two parallel rotating shafts are respectively driven by a driving gear and a driven gear, and the driving gear and the driven gear are engaged to each other.

8. The internal mixing extruder according to claim 1, wherein the screw refers to conical twin screws, a single screw or parallel twin screws.
